(19) United States
(12) Patent Application Publication
(10) Pub. No.: US 2007/0184225 A1
(43) Pub. Date: Aug. 9, 2007

(54) Polypropylene based monolayer film and use thereof

(75) Inventors: Masahiko Okamoto, Chiba-shi (JP); Takashi Nakagawa, Ichihara-shi (JP); Yasushi Tohi, Ichihara-shi (JP)

Correspondence Address: FOLEY AND LARDNER LLP;SUITE 500, 3000 K STREET NW, WASHINGTON, DC, 20007, US

(73) Assignee: Mitsui Chemicals, Inc.

(21) Appl. No.: 11/645,788

(22) Filed: Dec. 27, 2006

(30) Foreign Application Priority Data
Dec. 28, 2005 (JP) 2005-378197

(51) Int. Cl. B32B 1/02; B32B 27/32

(52) U.S. Cl. 428/35.7; 428/523; 526/348.1

(57) ABSTRACT

Monolayer and multilayer polypropylene-based films are provided which are excellent in not only heat resistance but also all of transparency, flexibility and impact resistance. The polypropylene-based monolayer film has a thickness of 100 to 400 μm and satisfies Requirements (1) to (4) below all together. The multilayer film includes the monolayer film as the base layer. (1) The Young's modulus measured in accordance with JIS K6781 is 500 MPa or less.
(2) The tensile impact strength measured at 0° C. is 100 to 1000 kJ/m². (3) The light transmittance is 85 to 99%, and the reduction rate of light transmittance after hot-water treatment at 120° C. for 30 minutes is less than 15% of the light transmittance before the treatment.
(4) The film is composed of 5 to 60 wt % of a component soluble in n-decane at room temperature (Dₛₒₗ) and 40 to 95 wt % of a component insoluble in n-decane at room temperature (Dᵢₙₛₒₗ).

### BACKGROUND OF THE INVENTION

1. Field of the Invention

The present invention relates to a conventionally known polypropylene-based film and its use. In more detail, it relates to a polypropylene-based monolayer film excellent in heat resistance, transparency, and low-temperature impact resistance, and a multilayer film with said film as a constituent layer.

2. Description of the Related Art

The industrial application fields of plastics have been more diversified and high-graded, and the application has advanced into a variety of industrial fields to which existing propylene-based resins alone cannot sufficiently respond. Among such fields, films for food containers and medical containers are required to have high heat resistance, flexibility, low-temperature impact resistance, and transparency in a balanced manner.

In recent years, retort food has rapidly been prevailing not only in household use but also in food service business, and therefore, there is a demand for development of materials for packaging (retort pouches) with which a large amount of food can be packaged at a time. Since retort foods are generally stored over a long period of time at room temperature, or in a refrigerator or a freezer, films used for the packaging materials are required to have high heat seal strength and low-temperature impact strength for preventing damage of contents in the heat-sealed part of the package. In addition, as retort foods are sterilized in an autoclave at approximately 100 to 140° C. after food is packed and sealed, the heat-sealed part should have high heat resistance and heat seal strength enough to endure the treatment from the viewpoint of quality control of food. Meanwhile, sterilization at a high temperature in a short time will improve not only the work efficiency, but also the survival rate of the food in the container. Accordingly, the industry demands further improvement in the allowable temperature limit of propylene-based resin which is commonly used in a sealant layer or the like of retort pouches (see Patent Document 1).

Conventional medical containers have been made of relatively flexible soft vinyl chloride resin or ethylene/vinyl acetate copolymer resin in many cases. Medical bags made of these resins are a closed system dispensing with vent needle for intravenous drip, and therefore have an advantage in preventing contamination derived from outside air. However, medical bags made of soft vinyl chloride resin contain additives, such as a plasticizer and a stabilizer, and therefore require preventing elution thereof. Medical bags made of ethylene/vinyl acetate copolymer resin are required to be crosslinked because of poor heat resistance (see Patent Documents 2 and 3).
Patent Document 1: JP-A-H09-216640
Patent Document 2: JP-A-2005-053131
Patent Document 3: JF-A-2004-244044

### SUMMARY OF THE INVENTION

The present invention has been conducted in light of the above related art and directed to providing monolayer and multilayer polypropylene-based films excellent in all of heat resistance, transparency, flexibility, and impact resistance.

That is, the present invention relates to a polypropylene-based monolayer film of 100 to 400 μm in thickness satisfying Requirements (1) to (4) below all together.

(1) The Young's modulus measured in accordance with JIS K6781 is 500 MPa or less.

(2) The tensile impact strength measured at 0° C. is 100 to 1000 kJ/m².

(3) The light transmittance is 85 to 99%, and the reduction rate of light transmittance after hot-water treatment at 120° C. for 30 minutes is less than 15% of the light transmittance before the treatment.

(4) The film is composed of 5 to 60 wt % of a component soluble in n-decane at room temperature (Dₛₒₗ) and 40 to 95 wt % of a component insoluble in n-decane at room temperature (Dᵢₙₛₒₗ).

Preferably, the polypropylene-based monolayer film of the present invention satisfies, in addition to Requirements (1) to (4), the requirement that the component soluble in n-decane at room temperature (Dₛₒₗ) is composed of 50 to 80 mol % of propylene-derived unit (S_{P}), 10 to 45 mol % of ethylene-derived unit (S_{E}), and 2.0 to 15 mol % of C₄₋₁₀ α-olefin-derived unit (S_{α}), provided that S_{P}+S_{E}+S_{α}=100 mol % (hereafter, simply called “Requirement (5)”).

The polypropylene-based monolayer film of the present invention preferably satisfies, in addition to Requirements (1) to (4), the requirement that the component soluble in n-decane at room temperature (Dₛₒₗ) has an intrinsic viscosity of 2.0 to 4.0 (dl/g) (hereafter, simply called “Requirement (6)”).

The polypropylene-based monolayer film of the present invention is preferably formed by an inflation or extrusion method.

The present invention relates to a multilayer film comprising a base layer and an outer layer on at least one surface of the base layer, the base layer comprising the polypropylene-based monolayer film, the outer layer comprising a polyolefin-based resin.

The present invention relates to food containers comprising the above polypropylene-based film.

The present invention relates to medical containers comprising the above polypropylene-based film.

The food containers of the present invention are preferably food containers usable for high-temperature sterilization.

The medical containers of the present invention are preferably medical containers usable for high-temperature sterilization.

The present invention relates to a process for producing a retort food package, comprising packaging food in the above food container and sterilizing the food at a high temperature.

The present invention relates to a process for producing a medical package, comprising packaging a medicine in the above medical container and sterilizing the medicine at a high temperature.

### DETAILED DESCRIPTION OF THE PREFERRED EMBODIMENTS

The polypropylene-based film of the present invention does not suffer from deterioration of transparency after high-temperature sterilization, and it is excellent in low-temperature impact resistance and flexibility.

The polypropylene-based transparent film of the present invention is specifically described below.

The polypropylene-based monolayer film of the present invention satisfies Requirements (1) to (4), which will be described in detail below, all together. The polypropylene-based monolayer film preferably satisfies one or more requirements selected from Requirements (5) and (6) along with Requirements (1) to (4), and particularly preferably it satisfies both Requirements (5) and (6) along with Requirements (1) to (4).

The thickness of the monolayer film is 100 to 400 μm, preferably 150 to 350 μm, and more preferably 200 to 300 μm. This thickness is preferable because the film satisfying Requirements (1) to (4) all together can be formed in a stable manner.

Requirement (1)

In the polypropylene-based monolayer film of the present invention, the Young's modulus measured in accordance with JIS K6781 is 500 MPa or less, preferably 10 to 400 MPa. It is not preferable that the Young's modulus is out of this range, because the film often fails to maintain flexibility corresponding to Young's modulus not more than 500 MPa before and after retort treatment (pressurized hot-water sterilization).

Requirement (2)

In the polypropylene-based monolayer film of the present invention, the tensile impact strength measured at 0° C. is 100 to 1000 kJ/m², and preferably 100 to 800 kJ/m². With the tensile impact strength being less than 100 kJ/m², dropping a container made of the propylene monolayer film that has been stored at a low temperature can result in leakage of the food or medicine from the container. On the other hand, there are a lot of difficulties in economical production of a film that has a tensile impact strength over 1000 kJ/m² and also satisfies the other requirements necessary for the polypropylene-based monolayer film of the present invention. Therefore, it is not preferred that the tensile impact strength be outside the above range.

Requirement (3)

The light transmittance of the polypropylene-based monolayer film of the present invention is 85 to 99%, preferably 85 to 95%, and the reduction rate of light transmittance after hot-water treatment at 120° C. for 30 minutes is less than 15%, preferably less than 10%, of the light transmittance before the treatment. When the light transmittance is less than 85%, it may be difficult to identify the contents by visual examination from the outside of container for some types of contents. Meanwhile, it is not practical to produce a film that has a light transmittance over 99% and also satisfies all the other requirements necessary for the polypropylene-based monolayer film of the present invention. When the reduction rate of light transmittance is not less than 15% after hot-water treatment, the transparency will be significantly deteriorated after high-temperature sterilization at 121° C.
Reduction rate of light transmittance (%)=(transmittance before thermal treatment−transmittance after thermal treatment)×100/transmittance before thermal treatment
Requirement (4)

The polypropylene-based monolayer film of the present invention is composed of a component soluble in n-decane at room temperature (Dₛₒₗ) in an amount of 5 to 60 wt %, preferably 10 to 60 wt %, more preferably 15 to 55 wt %, and a component insoluble in n-decane at room temperature (Dᵢₙₛₒₗ) in an amount of 40 to 95 wt %, preferably 40 to 90 wt %, more preferably 45 to 85 wt % (provided that the total of Dₛₒₗ and Dᵢₙₛₒₗ is 100 wt %). When this requirement is met, the polypropylene-based monolayer film is excellent in heat resistance, transparency, low-temperature impact strength, and flexibility, and especially excellent in the balance between low-temperature impact strength and transparency.

Requirement (5)

In the component soluble in n-decane at room temperature (Dₛₒₗ) of the polypropylene-based monolayer film of the present invention, the content of propylene-derived unit (S_{P}) is preferably 50 to 80 mol % and more preferably 55 to 80 mol %, the content of ethylene-derived unit (S_{E}) is 10 to 45 mol % and preferably 12 to 40 mol %, and the content of C₄₋₁₀ α-olefin-derived unit (S_{α}) is preferably 2.0 to 15 mol % and more preferably 2.0 to 13 mol %, provided that S_{P}+S_{E}+S_{α}=100 mol %. When Dₛₒₗ contains the propylene-derived constitutional unit, ethylene-derived constitutional unit, and C₄₋₁₀ α-olefin-derived constitutional unit at a ratio in the above range, the polypropylene-based monolayer film tends to have sufficient transparency, flexibility, mechanical strength, heat resistance, and impact resistance.

Requirement (6)

In the polypropylene-based monolayer film of the present invention, the intrinsic viscosity [η] of the component soluble in n-decane at room temperature (Dₛₒₗ) is preferably 2.0 to 4.0 (dl/g), more preferably 2.0 to 3.5, and especially preferably 2.0 to 3.2 (dl/g). When the intrinsic viscosity [η] of Dₛₒₗ falls within the range, the polypropylene-based monolayer film is excellent in heat resistance, transparency, low-temperature impact resistance, and flexibility, and especially excellent in the balance between low-temperature impact resistance and transparency.

Polypropylene Film

The polypropylene-based monolayer film of the present invention has no limitation on the methods of producing the propylene-based resin or propylene-based resin composition, which are the source materials of the film, and the constitution and the forming method of the propylene-based resin or propylene-based resin composition or the like, as long as the above properties are satisfied. Hereinafter, the process of producing a typical monolayer film, which was used in Examples of the present application described later, will be described. The propylene-based resin composition used in Examples of the present invention may be prepared by physical blending or reactor blending of a propylene homopolymer or a random polypropylene, wherein the content of a unit derived from ethylene or α-olefin is 8 mol % or less, preferably 6 mol % or less, the propylene homopolymer or random polypropylene being prepared with a common Ziegler-Natta catalyst or metallocene catalyst (hereafter, these polymers may be called simply “propylene polymer (A)”); a propylene copolymer (B) prepared by copolymerization of propylene, ethylene, and a C₄₋₁₀ α-olefin in the presence of a polymerization catalyst containing a metallocene compound represented by general formula [I] below, which is described in WO 2005/019283 filed by the present applicant; and, if necessary, an ethylene copolymer (C) prepared by copolymerization of ethylene and a C₄₋₁₀ α-olefin with a common Ziegler-Natta catalyst or metallocene catalyst. In Examples of the present invention, diphenylmethylene(3-tert-butyl-5-ethylcyclopentadienyl)(2,7-di-tert-butylfluorenyl) zirconium dichloride was used as the metallocene compound represented by general formula [I]. 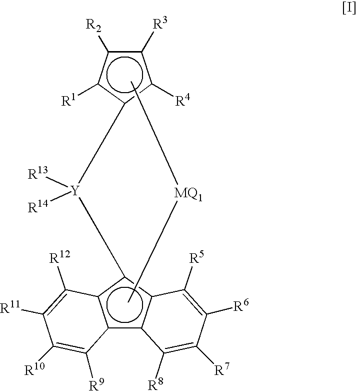
(In general formula [I], R¹, R², R³, R⁴, R⁵, R⁶, R⁷, R⁸, R⁹, R¹⁰, R¹¹, R¹², R¹³ and R¹⁴ may be the same as or different from each other and are each selected from a hydrogen atom, hydrocarbon groups, and silicon-containing groups. M is a Group-4 transition metal, Y is a carbon or silicon atom, Q is selected from halogen atoms, hydrocarbon groups, anionic ligands, and neutral ligands capable of coordinating via a lone pair and may be the same or a combination of different groups, and j is an integer of 1 to 4.)

The polypropylene polymer (A), propylene copolymer (B), and ethylene copolymer (C), which is optionally used as necessary, prepared as mentioned above are blended with additives of every kind if necessary, such as an antioxidant, an ultraviolet absorber, an antistatic agent, a nucleating agent, a lubricant, a flame retardant, an antiblocking agent, a colorant, an inorganic or organic filler, and a synthetic resin. The combined materials are melt-kneaded and pelletized to make pellets. The pellets are formed into the polypropylene-based monolayer film of the present invention by extrusion or inflation.

A preferable forming method is an inflation method or a (co) extrusion T-die method from hygienic and economic points of view.

That is, the film is prepared by the inflation method in which the above pellets are melt-extruded with an extruder and a circular die, extruded through a spiral or slit die, and inflated at a predetermined air flow. The cooling methods include water-cooling and air-cooling.

The conditions for water-cooling inflation are not particularly restricted, but the forming temperature is preferably 190 to 280° C. and the water temperature during water-cooling is preferably 10 to 60° C.

The film is also formed by the extrusion method in which the above pellets are melt-extruded with an extruder and a circular die, extruded through a coat-hanger die and a T-die, and cooled. A multilayer film is prepared, for example, by a multilayer T-die method, dry lamination, extrusion lamination, or the like. Although the forming conditions are not particularly restricted, the forming temperature is preferably 190 to 280° C. and the cooling temperature of a chill roll is preferably 10 to 80° C.

As mentioned above, the polypropylene-based monolayer film of the present invention is not only used as a monolayer film but also suitably used in a multilayered film prepared by co-extrusion. The present invention also includes such a co-extruded multilayer film in which the base layer is the polypropylene-based monolayer film and outer layer(s) made of polyolefin-based resin is (are) laminated onto at least one surface of the base layer. A preferred embodiment of the multilayer film is a three-layered film composed of the above polypropylene monolayer film of the present invention, on both sides of which there is laminated a film of 10 to 50 μm, preferably 15 to 40 μm, in thickness made of polypropylene or random polypropylene containing the unit derived from ethylene or α-olefin in an amount of 8 mol % or less, preferably 6 mol % or less. This three-layered film is suitably applied to uses described below.

The multilayer film may be composed of four or more layers. Although not particularly specified, when the multilayer film has a thickness of 250 μm, the thickness of the polypropylene monolayer film of the present invention is preferably 150 μm or more. With this thickness, the film is excellent in the balance among flexibility, transparency and impact resistance. The constituent layers include a gas barrier layer, an adhesive layer, and the like. For the gas barrier layer, PET, EVOH, cycloolefin polymers, and vapor-deposited aluminum are preferably used. For the adhesive layer, polar group-containing olefin polymers (ADMER) are suitably used. In producing a food container or medicine container using the monolayer or multilayer film of the present invention prepared in the above method, the tubular or sheet-shaped film prepared by the above forming method is cut and heat-sealed by the common method, and an opening member or the like is attached to the container body by means of heat-sealing or the like, thereby producing a container in a predetermined shape and size. The temperature for heat-sealing of the film is generally about 120 to 180° C., although dependent on the film thickness. It is preferable that the opening member be composed of a film of linear low density polyethylene or an ethylene/α-olefin copolymer-based resin, because such film is easily welded to the inner layer of the film of the present invention.

### EXAMPLES

The present invention will be described more specifically with Examples below, but the present invention is not restricted to these Examples.

The analytical methods employed in the present invention are as follows.

[m1] Content of Component Soluble in n-decane at Room Temperature (Dₛₒₗ)

To the monolayer film (20 cm×20 cm) of the present invention, 200 mL of n-decane was added, and the film was dissolved by heating at 145° C. for 30 minutes. The solution was cooled to 20° C. in approximately 3 hours and let stand for 30 minutes. The resultant precipitate (hereafter called n-decane-insoluble component, Dᵢₙₛₒₗ) was filtered off. The filtrate was poured into acetone in about 3 times volume of the filtrate to precipitate the component dissolved in n-decane. The mixture was filtered to separate precipitate (A) from acetone, and the precipitate was dried. Although the filtrate was concentrated to drying, no residue was found. The content of n-decane-soluble component was obtained by the following equation:
Content of n-decane-soluble component (wt %)=[weight of precipitate (A)/weiqht of sample]×100
[m2] Molecular Weight Distribution (Mw/Mn) [Weight-average Molecular Weight (Mw), Number-average Molecular Weight (Mn)]

Measurement was carried out using GPC-150C Plus manufactured by Waters as follows. The separation columns were TSKgel GMH6-HT and TSKgel GMH6-HTL, each sized 7.5 mm in inside diameter and 600 mm in length, the column temperature was 140° C., the mobile phase was o-dichlorobenzene (Wako Pure Chemical Industries, Ltd.) containing 0.025 wt % of BHT (Wako Pure Chemical Industries, Ltd.) as an antioxidant, the flow rate was 1.0 mL/min, the sample concentration was 0.1 wt %, the injection volume of sample was 500 μL, and the detector used was a differential refractometer. Standard polystyrenes manufactured by Tosoh Corporation were used for the molecular weight range of Mw<1,000 and Mw>4×10⁶, and those manufactured by Pressure Chemical Company were used for the molecular weight range of 1,000 ≦Mw<4×10⁶. The conversion to PP was based on a universal calibration method. The Mark-Houwink coefficients of PS and PP were quoted from the values in J. Polym. Sci., Part A-2, 8 1803 (1970) and Makromol. Chem., 177, 213 (1976), respectively.

[m3] Melting Point (Tm)

Measurement was carried out with a differential scanning calorimeter (DSC, manufactured by PerkinElmer, Inc.). Here, the endothermic peak in the third step was defined as the melting point (Tm).

(Measurement Conditions)

The first step: The temperature was raised to 240° C. at 10° C./min and maintained constant for 10 minutes.

The second step: The temperature was lowered to 60° C. at 10° C./min.

The third step: The temperature was raised to 240° C. at 10° C./min.

[m4] Intrinsic Viscosity [η]

Measurement was carried out at 135° C. using decalin as a solvent. In 15 mL of decalin was dissolved 1 cm² of the polypropylene-based monolayer film of the present invention, and the specific viscosity ηₛₚ was measured in an oil bath at 135° C. This solution was diluted by adding 5 mL of decalin, and the specific viscosity ηₛₚ was measured in the same way. The dilution procedure was repeated two more times, and the extrapolated value of ηₛₚ /C at the concentration (C) approaching 0 was determined as the intrinsic viscosity.

[η]=lim(ηₛₚ/C) (C→0)

[m5] Content of Propylene-derived Unit (S_{P}), Content of Ethylene-derived Unit (S_{E}), and Content of C₄₋₁₀ α-olefin-derived Unit (S_{α}) in Dₛₒₗ

About 1 cm² of the polypropylene-based monolayer film of the present invention was dissolved in 0.6 mL of 1,2,4-trichlorobenzene/benzene-d₆ (2:1) solution, and the carbon nuclear magnetic resonance (¹³C-NMR) spectrum was measured. The contents of propylene, ethylene, and α-olefin were quantified based on the dyad distribution. In the case of propylene/ethylene copolymer, for instance, equations (Eq-1) and (Eq-2) below were used together with the relations PP=Sαα, EP=Sαγ+Sαβ, and EE=(Sβδ+Sδδ)/2+Sγδ/4.
propylene(mol %)=[(PP+(EP/2)]×100/{[PP+(EP/2)]+[(EP/2)+EE]}
ethylene(mol %)=([(EP/2)+EE]×100/{[PP+(EP/2)]+[(EP/2)+EE]}
[m6] MFR (Melt Flow Rate)

MFR was measured in accordance with ASTM D1238 (230° C., 2.16 kg of loading)

[m7] Young's Modulus of Film (=Tensile Elastic Modulus)

The Young's modulus of the film was measured in accordance with JIS K 6781.

<Test conditions>

Temperature: 23° C.

Tensile speed: 30 mm/min

Distance between chucks: 30 mm

[m8] Tensile Impact Strength of Film

The film was heat-sealed at 200/190° C. (upper limit/lower limit) under 0.2 MPa for 5 seconds with the seal width of 150 mm×20 mm using heat-seal testing machine TP-701-B manufactured by Tester Sangyo Co., Ltd. to prepare a test sample.

The above sample was cut into rectangular shape of 10 mmt in accordance with JIS K7160 to make a specimen. Tensile impact test was carried out at a hammer lift angle of 149.2° at an impact speed of 3.0 m/sec using universal impact test machine 258 manufactured by Yasuda Seiki Seisakusho, Ltd.

[m9] Light Transmittance of Film

Measurement was carried out in accordance with JIS K7136 using benzyl alcohol as a solvent. After the film was annealed with hot water at 120° C. in an autoclave for 30 minutes, the measurement was carried out in the same way, and the reduction rate of light transmittance was calculated.

Examples will be described in detail below.

### Polymerization Example 1

### Synthesis of propylene/ethylene/butene copolymer (B-1)

A4-L polymerization reactor, which had been fully purged with nitrogen, was charged with 1834 mL of dry hexane, 110 g of 1-butene, and triisobutylaluminum (1.0 mmol) at room temperature. The inside temperature of the polymerization reactor was raised to 55° C., propylene was supplied so that the inner pressure of the system was 0.58 MPa, and then ethylene was supplied so as to adjust the inner pressure to 0.75 MPa. To the polymerization reactor was added a toluene solution in which 0.001 mmol of diphenylmethylene(3-tert-butyl-5-ethylcyclopentadienyl)(2,7-di-tert-butylfluorenyl) and 0.3 mmol (in terms of aluminum) of methylaluminoxane (Tosoh Finechem Corporation) were contacted. Polymerization was performed for 25 minutes while the inside temperature was kept at 55° C. and ethylene was supplied so that the inner pressure of the system was kept at 0.75 MPa. To terminate the polymerization, 20 mL of methanol was then added. After releasing the pressure, the polymerization solution was poured into 4 L of methanol to precipitate the polymer, which was dried at 130° C. under vacuum for 12 hours. The resultant polymer weighed 120.2 g. In this polymer (B-1), [η] was 2.6 (dl/g), Mw/Mn was 2.1, the content of propylene-derived unit was 74.9 mol %, the content of ethylene-derived unit was 18.5 mol %, and the content of butene-derived unit was 6.6 mol %. The physical properties including other properties are shown in Table 1. The above procedure was repeated until a required amount of the polymer was obtained. The polymer was melt-kneaded and used for Examples described below.

### Example 1

A composition contained 37.5 parts by weight of propylene polymer (A-1) (MFR=7.3) with the properties shown in Table 1, 37.5 parts by weight of propylene polymer (A-2) (MFR=0.5) shown in Table 1, 25 parts by weight of propylene/ethylene/butene copolymer (B-1) prepared in Polymerization Example 1 (100 parts by weight in total), and 25 parts by weight of ethylene/butene copolymer (C-1). To the composition were added 0.1 part by weight of tris(2,4-di-tert-butylphenyl) phosphate as a secondary antioxidant, 0.1 part by weight of n-octadecyl 3-(4′-hydroxy-3′,5′-di-tert-butylphenyl)propionate as a heat resistant stabilizer, and 0.05 part by weight of calcium stearate as a hydrochloric acid absorber. The mixture was kneaded with twin-screw extruder BT-30 manufactured by Plabor Co., Ltd. (30 mm, L/D=46, rotating in the same direction) at a preset temperature of 200° C. at a resin extrusion output of 60 g/min at a rotation of 200 rpm to prepare pellets.

The resultant pellets were extruded by using a single-screw extruder (20 mm in diameter, L/D=28, manufactured by Therm Co. Ltd.) equipped with a T-die having a diameter of 25 mm and a lip width of 250 mm×2.0 mm, at a processing temperature of 210° C., at a roll temperature of 40° C. at a winding speed of 0.63 m/min to give a film of 250 μm in thickness.

In the monolayer film, the mean thickness was 250 μm, the Young's modulus was 180 MPa, the strength at break was 50 MPa, the tensile impact strength was 200 kJ/m², the light transmittance was 92%, and the light transmittance after hot-water treatment at 120° C. for 30 minutes was 84%, and hence the reduction rate was 8.7%. In the monolayer film, it was found that the component soluble in decane at room temperature (Dₛₒₗ) accounted for 24 wt % and the component insoluble in decane at room temperature (Dᵢₙₛₒₗ) 76 wt %. For the component soluble in decane at room temperature (Dₛₒₗ), the intrinsic viscosity was 2.7 dl/g, the content of propylene-derived unit (S_{P}) was 56.1 mol %, the content of ethylene-derived unit (S_{E}) was 36.9 mol %, and the content of 1-butene-derived unit (S_{α}) was 7.0 mol %. These results are shown in Table 2.

### Example 2

A composition contained 30 parts by weight of propylene polymer (A-1) (MFR=7.3) with the properties shown in Table 1, 30 parts by weight of propylene polymer (A-2) (MFR=0.5) with the properties shown in Table 1, and 40 parts by weight of propylene/ethylene/butene copolymer (B-1) prepared in Polymerization Example 1 (100 parts by weight in total). To the composition were added the same secondary antioxidant, heat resistant stabilizer, and hydrochloric acid absorber in the same amounts as in EXAMPLE 1. The mixture was kneaded under the same extrusion conditions to give pellets.

The resultant pellets were extruded by using a single-screw extruder (20 mm in diameter, L/D=28, manufactured by Therm Co., Ltd.) equipped with a T-die having a diameter of 25 mm and a lip width of 250 mm×2.0 mm, at a processing temperature of 210° C. at a roll temperature of 40° C. at a winding speed of 0.63 m/min to give a film of 250 μm in thickness.

In the monolayer film, the mean thickness was 250 μm, the Young's modulus was 160 MPa, the strength at break was 37 MPa, the tensile impact strength was 190 kJ/m², the light transmittance was 96%, and the light transmittance after hot-water treatment at 120° C. for 30 minutes was 91%, and hence the reduction rate was 5.2%. In the monolayer film, it was found that the component soluble in decane at room temperature (Dₛₒₗ) accounted for 40 wt % and the component insoluble in decane at room temperature (Dᵢₙₛₒₗ) 60 wt %. For the component soluble in decane at room temperature (Dₛₒₗ), the intrinsic viscosity was 2.6 dl/g, the content of propylene-derived unit (S_{P}) was 74.9 mol %, the content of ethylene-derived unit (S_{E}) was 18.5 mol %, and the content of 1-butene-derived unit (S_{α}) was 6.6 mol %.

### Example 3

A composition contained 25 parts by weight of propylene polymer (A-1) (MFR=7.3) with the properties shown in Table 1, 25 parts by weight of propylene polymer (A-2) (MFR=0.5) with the properties shown in Table 1, 50 parts by weight of the propylene/ethylene/butene copolymer (B-1) prepared in Polymerization Example 1 (100 parts by weight in total), and 25 parts by weight of ethylene/butene copolymer (C-1). To the composition were added the same secondary antioxidant, heat resistant stabilizer, and hydrochloric acid absorber in the same amounts as in EXAMPLE 1. The mixture was kneaded under the same extrusion conditions to give pellets.

The resultant pellets were extruded by using a single-screw extruder (20 mm in diameter, L/D=28, manufactured by Therm Co., Ltd.) equipped with a T-die having a diameter of 25 mm and a lip width of 250 mm×2.0 mm, at a processing temperature of 210° C., at a roll temperature of 40° C. at a winding speed of 0.63 m/min to give a film of 250 μm in thickness.

In the monolayer film, the mean thickness was 250 μm, the Young's modulus was 100 MPa, the strength at break was 46 MPa, the tensile impact strength was 260 kJ/m², the light transmittance was 92%, and the light transmittance after hot-water treatment at 120° C. for 30 minutes was 88%, and hence the reduction rate was 4.3%. In the monolayer film, it was found that the component soluble in decane at room temperature (Dₛₒₗ) accounted for 47 wt % and the component insoluble in decane at room temperature (Dᵢₙₛₒₗ) 53 wt %. For the component soluble in decane at room temperature (Dₛₒₗ), the intrinsic viscosity was 2.5 dl/g, the content of propylene-derived unit (S_{P}) was 61.5 mol %, the content of ethylene-derived unit (S_{E}) was 30.6 mol %, and the content of 1-butene-derived unit (S_{α}) was 7.9 mol %.

### Comparative Example 1

Propylene polymer (A-1) (MFR=7.3) with the properties shown in Table 1 was extruded by using a single-screw extruder (20 mm in diameter, L/D=28, manufactured by Therm Co., Ltd.) equipped with a T-die having a diameter of 25 mm and a lip width of 250 mm×2.0 mm, at a processing temperature of 210° C., at a roll temperature of 40° C. at a winding speed of 0.63 m/min to give a film of 250 μm in thickness.

In the monolayer film, the mean thickness was 250 μm, the Young's modulus was 800 MPa, the tensile impact strength was 30 kJ/m², the light transmittance was 85%, and the light transmittance after hot-water treatment at 120° C. for 30 minutes was 81%, and hence the reduction rate was 4.7%. In the monolayer film, it was found that the component soluble in decane at room temperature (Dₛₒₗ) accounted for 2 wt % and the component insoluble in decane at room temperature (Dᵢₙₛₒₗ) 98 wt %.

TABLE 1

| | | | Propylene | | Propylene | Ethylene |
|---|---|---|---|---|---|---|
| | | | Polymer | | Copolymer | Copolymer |
| | | | (A-1) | (A-2) | (B-1) | (C-1) |
| Compo- | (a) Propylene unit | (mol %) | 95.2 | 93.4 | 74.9 | 0.0 |
| sition | (b) Ethylene unit | (mol %) | 3.3 | 6.6 | 18.5 | 85.5 |
| | (c) α-olefin unit | (mol %) | 1.5 | 0.0 | 6.6 | 14.5 |

| | | | | | |
|---|---|---|---|---|---|
| MFR | (g/10 min) | 7.3 | 0.5 | — | — |
| [η] | | | | 2.6 | 3.0 |
| Mw/Mn | | — | — | 2.1 | — |
| Melting Point Tm | (° C.) | 138.5 | 137.2 | — | 56.1 |
| [symbol] H | (mJ/mg) | 76 | 65 | — | 37 |
| Tg | (° C.) | — | — | −30.0 | −51.8 |

TABLE 2

| | | | | | | Comparative |
|---|---|---|---|---|---|---|
| | | | Example | | | Example |
| | | | 1 | 2 | 3 | 1 |
| Polymer (A) | | | (A-1)/(A-2) | (A-1)/(A-2) | (A-1)/(A-2) | (A-1) |
| Copolymer (B) or (C) | | | (B-1)/(C-1) | (B-1) | (B-1)/(C-1) | — |
| (A)/(B) or (C) composition ratio (wt %) | | | 37.5/37.5/25/25 | 30/30/40 | 25/25/50/25 | 100 |
| Tensile elastic modulus | | (MPa) | 180 | 160 | 100 | 800 |
| Tensile impact strength | | (kJ/m²) | 200 | 190 | 260 | 30 |
| Light transmittance | | (%) | 92 | 96 | 92 | 65 |
| Light transmittance after heat treatment | | (%) | 64 | 91 | 88 | 81 |
| Content of decane soluble component | | (%) | 21 | 40 | 47 | 2 |
| [η] of decane soluble component | | (dl/g) | 2.7 | 2.6 | 2.5 | — |
| Decane | (a) Propylene unit | (mol %) | 56.1 | 74.9 | 61.5 | — |
| Soluble | (b) Ethylene unit | (mol %) | 36.9 | 18.5 | 30.6 | — |
| Component | (c) α-olefin unit | (mol %) | 7.0 | 6.6 | 7.9 | — |

The polypropylene-based film does not suffer from deterioration in transparency even after high-temperature sterilization treatment and is excellent in low-temperature impact resistance and flexibility, and is useful in the fields of food packaging and medical packaging.

1. A polypropylene-based monolayer film of 100 to 400 μm in thickness satisfying Requirements (1) to (4) below all together:
(1) the Young's modulus measured in accordance with JIS K6781 is 500 MPa or less;
(2) the tensile impact strength measured at 0° C. is 100 to 1000 kJ/m²;
(3) the light transmittance is 85 to 99%, and the reduction rate of light transmittance after hot-water treatment at 120° C. for 30 minutes is less than 15% of the light transmittance before the treatment; and
(4) the film is composed of 5 to 60 wt % of a component soluble in n-decane at room temperature (Dₛₒₗ) and 40 to 95 wt % of a component insoluble in n-decane at room temperature (Dᵢₙₛₒₗ).

2. The polypropylene-based monolayer film according to claim 1, wherein the component soluble in n-decane at room temperature (Dₛₒₗ) is composed of 50 to 80 mol % of propylene-derived unit (S_{P}), 10 to 45 mol % of ethylene-derived unit (S_{E}), and 2.0 to 15 mol % of unit derived from an α-olefin having 4 to 10 carbon atoms (S_{α}), provided that S_{P}+S_{E}+S_{α}=100 mol %.

3. The polypropylene-based monolayer film according to claim 1, wherein the component soluble in n-decane at room temperature (Dₛₒₗ) has an intrinsic viscosity of 2.0 to 4.0 dl/g.

4. The polypropylene-based monolayer film according to claim 1, wherein the film is formed by an inflation or extrusion method.

5. A multilayer film comprising a base layer and an outer layer on at least one surface of the base layer, the base layer comprising the polypropylene-based monolayer film according to claim 1, the outer layer comprising a polyolefin-based resin.

6. A food container comprising the polypropylene-based film according to claim 1.

7. A medical container comprising the polypropylene-based film according to claim 1.

8. The food container according to claim 6 that is a food container usable for high-temperature sterilization.

9. The medical container according to claim 7 that is a medical container usable for high-temperature sterilization.

10. A process of producing a retort food package, comprising packaging food in the food container according to claim 6 and sterilizing the food at a high temperature.

11. A process of producing a medical package, comprising packaging a medicine in the medical container according to claim 7 and sterilizing the medicine at a high temperature.
